(19) United States
(12) Patent Application Publication
(10) Pub. No.: US 2025/0327978 A1
(43) Pub. Date: Oct. 23, 2025

(54) Hybrid Fiber and Electrical Connector and Adapter

(71) Applicant: Panduit Corp., Tinley Park, IL (US)

(72) Inventors: Yu Huang, Orland Park, IL (US); Ryan N. Murphy, Monee, IL (US); Masud Bolouri-Saransar, Orland Park, IL (US); Jose M. Castro, Naperville, IL (US); Thomas M. Sedor, Orland Park, IL (US); Satish I. Patel, Roselle, IL (US); Bulent Kose, Burr Ridge, IL (US); Benjamin S. Novak, Lockport, IL (US)

(73) Assignee: Panduit Corp., Tinley Park, IL (US)

(21) Appl. No.: 19/184,148

(22) Filed: Apr. 21, 2025

Related U.S. Application Data
(60) Provisional application No. 63/636,915, filed on Apr. 22, 2024.

(51) Int. Cl. G02B 6/38

(52) U.S. Cl. CPC G02B 6/3849; G02B 6/3825; G02B 6/3879

(57) ABSTRACT

A hybrid fiber optic connector and adapter assembly is provided as a solution for providing proper polarity when connecting hybrid cables that include both optical fiber and electrical wire together using connector and adapter assemblies.

### CROSS-REFERENCE TO RELATED APPLICATION(S)

This application claims benefit to U.S. Provisional Patent Application No. 63/636,915, filed on Apr. 22, 2024, the entirety of which is hereby incorporated by reference herein.

### TECHNICAL FIELD

The application relates to a hybrid fiber and electrical connector and adapter assembly that builds and improves upon existing fiber connector and adapter systems to provide efficient and effective transmission of electrical and optical signals from a hybrid cable.

### BACKGROUND

Conventional connectors often specialize in either electrical power transmission or optical data communication, necessitating the use of multiple connectors and cables to cater to diverse functionalities in various applications. The demand for streamlined and versatile connector solutions has steadily increased in numerous industries and application scenarios.

Recognizing the evolving needs for both fast data transmission and power delivery at remote locations, the hybrid connector emerges as a pioneering solution, adeptly surmounting the limitations of traditional connectors. This innovative hybrid connector seamlessly integrates the capabilities of transmitting electric power and optical data over a unified connector interface. This amalgamation of power delivery and data communication within a single hybrid connector presents many compelling advantages.

The present solution provides a hybrid connector and adapter system that further addresses polarity issues that may arise when transmitting electrical power signals.

### SUMMARY

Disclosed herein are exemplary new hybrid connector and adapter systems that are configured to provide a solution for misaligning proper polarity when connecting hybrid cables together using connector and adapter assemblies.

A hybrid cable connector is disclosed, the hybrid cable connector comprising a connector housing comprising: a first recessed channel formed at a bottom portion of the connector housing, the first recessed channel including a first wall and a second wall; and a second recessed channel formed at the bottom portion of the connector housing, the second recessed channel including a third wall and a fourth wall; and a pair of leaf springs including a first leaf spring and a second leaf spring, the first leaf spring installed inside the first recessed channel and the second leaf spring installed inside the second recessed channel attached to a bottom portion of the first connector housing; wherein the first wall and the second wall protrude higher than the first leaf spring installed inside the first recessed channel; wherein the third wall and the fourth wall protrude higher than the second leaf spring installed inside the second recessed channel.

A duplex hybrid cable connector is disclosed, the duplex hybrid cable connector comprising a first connector housing including a first top surface; a second connector housing including a second top surface; a first pair of conductive leaf springs installed onto the top surface of the first connector housing; a second pair of leaf springs attached installed onto the second top surface of the second connector housing; and a push-pull clip including an insulative protector configured to cover over at least a portion of the first pair of conductive leaf springs and the second pair of conductive leaf springs.

A hybrid cable connector is disclosed, the hybrid cable connector comprising a connector housing including a top surface and a bottom surface; a first set of conductive leaf springs installed onto the first top surface; a second set of leaf springs installed onto the bottom surface; and a push-pull clip including an insulative protector configured to cover over at least a portion of the first set of conductive leaf springs and the second set of conductive leaf springs.

A detailed description of these and other non-limiting exemplary embodiments of the hybrid cable connector and adapter assemblies is set forth below together with accompanying drawings.

### BRIEF DESCRIPTION OF THE DRAWINGS

FIG. 1 illustrates an exemplary fiber optic connector.

FIG. 2 illustrates a top-down view into an exemplary LC adapter.

FIG. 3A illustrates a perspective view of a duplex hybrid connector, according to some embodiments of the present disclosure.

FIG. 3B illustrates a perspective view of the duplex hybrid connector shown in FIG. 3A, where conductive leaf springs are shown outside of the duplex hybrid connector, according to some embodiments of the present disclosure.

FIG. 3C illustrates a front side view of the duplex hybrid connector shown in FIG. 3A, according to some embodiments of the present disclosure.

FIG. 4A illustrates a front side view of one hybrid connector from the duplex hybrid connector shown in FIG. 3A, according to some embodiments of the present disclosure.

FIG. 4B illustrates a sectional view of the hybrid connector shown in FIG. 4A, taken along the line 4B-4B, according to some embodiments of the present disclosure.

FIG. 5A illustrates a perspective view of a hybrid adapter for mating with the duplex hybrid connector shown in FIG. 3A, according to some embodiments of the present disclosure.

FIG. 5B illustrates an exploded view of the hybrid adapter shown in FIG. 5A, according to some embodiments of the present disclosure.

FIG. 5C illustrates a partially exploded view of the hybrid adapter shown in FIG. 5A, according to some embodiments of the present disclosure.

FIG. 6A illustrates a perspective view of the duplex hybrid connector shown in FIG. 3A and the hybrid adapter shown in FIG. 5A forming an assembly system, prior to an installed state, according to some embodiments of the present disclosure.

FIG. 6B illustrates a perspective view of the duplex hybrid connector shown in FIG. 3A and the hybrid adapter shown in FIG. 5A forming an assembly system, in an installed state, according to some embodiments of the present disclosure.

FIG. 7A illustrates a perspective view of an exemplary duplex hybrid connector, according to an alternative embodiment.

FIG. 7B illustrates an exploded view of the duplex hybrid connector shown in FIG. 7A, according to some embodiments of the present disclosure.

FIG. 8 illustrates a perspective view showing the duplex hybrid connector shown in FIG. 7A, without a protective housing, according to some embodiments of the present disclosure.

FIG. 9 illustrates a front side view showing the protective housing, according to some embodiments of the present disclosure.

FIG. 10 illustrates an exploded view of an exemplary hybrid adapter for mating with the duplex hybrid connector shown in FIG. 7A, according to an alternative embodiment of the present disclosure.

FIG. 11A illustrates a perspective view of the duplex hybrid connector shown in FIG. 7A and the hybrid adapter shown in FIG. 10 forming an assembly system, prior to an installed state, according to some embodiments of the present disclosure.

FIG. 11B illustrates a perspective view of the duplex hybrid connector shown in FIG. 7A and the hybrid adapter shown in FIG. 10 forming an assembly system, in an installed state, according to some embodiments of the present disclosure.

FIG. 12A illustrates a perspective view of an exemplary duplex hybrid connector, showing a top side of the duplex hybrid connector, according to an alternative embodiment of the present disclosure.

FIG. 12B illustrates a perspective view of the duplex hybrid connector shown in FIG. 12A, showing a bottom side of the duplex hybrid connector, according to some embodiments of the present disclosure.

FIG. 12C illustrates an exploded view of the duplex hybrid connector shown in FIG. 12A, according to some embodiments of the present disclosure.

FIG. 13 illustrates an exploded view of an exemplary hybrid adapter for mating with the duplex hybrid connector shown in FIG. 12A, according to an alternative embodiment of the present disclosure.

FIG. 14A illustrates a perspective view of the duplex hybrid connector shown in FIG. 12A and the hybrid adapter shown in FIG. 13 forming an assembly system, prior to an installed state, according to some embodiments of the present disclosure.

FIG. 14B illustrates a perspective view of the duplex hybrid connector shown in FIG. 12A and the hybrid adapter shown in FIG. 13 forming an assembly system, in an installed state, according to some embodiments of the present disclosure.

FIG. 15A illustrates a perspective view of an exemplary hybrid connector, according to an alternative embodiment.

FIG. 15B illustrates a front side view of the hybrid connector shown in FIG. 15A, according to some embodiments of the present disclosure.

FIG. 16A illustrates a perspective view of an exemplary hybrid adapter for mating with the hybrid connector shown in FIG. 15A, according to an alternative embodiment.

FIG. 16B illustrates an exploded view of the hybrid adapter shown in FIG. 16A, according to some embodiments of the present disclosure.

FIG. 17A illustrates a perspective view of the hybrid connector shown in FIG. 15A and the hybrid adapter shown in FIG. 16A forming an assembly system, prior to an installed state, according to some embodiments of the present disclosure.

FIG. 17B illustrates a perspective view of the hybrid connector shown in FIG. 15A and the hybrid adapter shown in FIG. 16A forming an assembly system, in an installed state, according to some embodiments of the present disclosure.

FIG. 18 illustrates an exemplary assembly system that includes the duplex hybrid fiber connector shown in FIG. 15A and the duplex hybrid adapter shown in FIG. 16A, communicating between transceivers, according to some embodiments of the present disclosure.

### DETAILED DESCRIPTION

A detailed description of non-limiting embodiments of various hybrid connectors and hybrid adapters are disclosed herein. It is to be understood that the disclosed embodiments are merely exemplary and may take various and alternative forms. The figures may not necessarily be to scale, and features may be exaggerated or minimized to show details of particular components. Therefore, specific structural and functional details disclosed herein may not to be interpreted as limiting, but merely as a representative basis for teaching one skilled in the art.

Hybrid connectors and adapters provide the benefits of substantially reducing installation costs, preventing the requirement for multiple connectors, intricate cabling, and the associated installation complexities when managing hybrid cables that include both optical fiber and conductive wires. Moreover, utilizing such hybrid connectors and adapters simplifies the infrastructure when managing hybrid cables, thus leading to tidier and more efficient cable management.

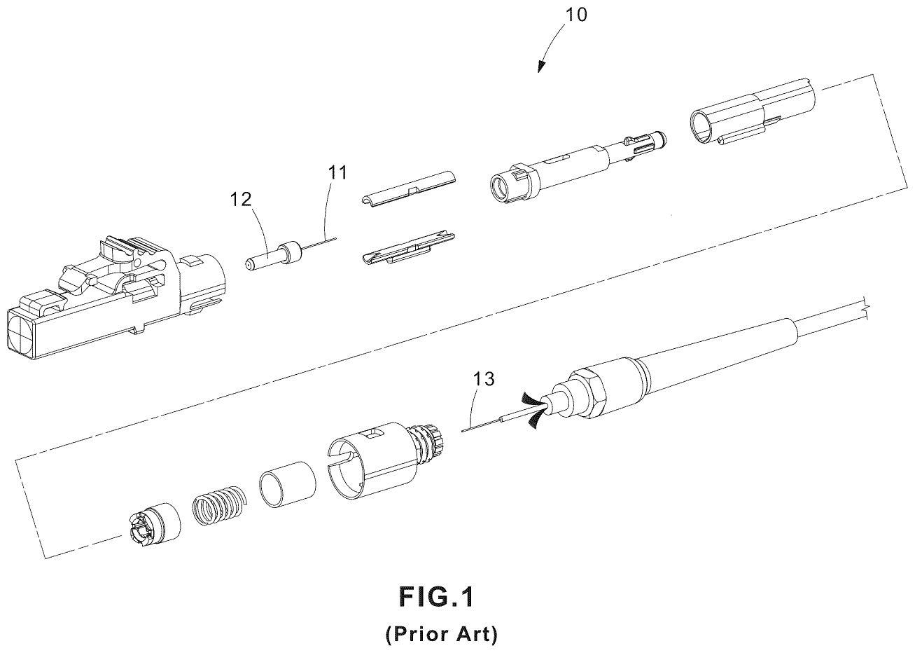

However, previous iterations of hybrid connectors are bulky and complicated to manufacture. Therefore, it is desirable to develop a compact hybrid connector with the size and footprint of a standard fiber optic connector (e.g., LC connector type or SC connector type or MPO connector type). Moreover, such hybrid fiber and electrical connectors could further be field terminated like the OptiCam fiber connector from Panduit Corp. described in U.S. Pat. Nos. 7,011,454 and 8,256,970, the entirety of both of which are hereby incorporated by reference herein, to bring convenience and more installation flexibility. FIG. 1 shows the fiber optic connector 10 that is field terminable. The fiber optic connector 10 includes a stub fiber 11 with one pre-polished end coming from the ferrule 12, allowing for rapid assembly with a field fiber, resulting in the swift creation of a fiber optic connector. Inside the fiber optic connector 10 is a field fiber 13.

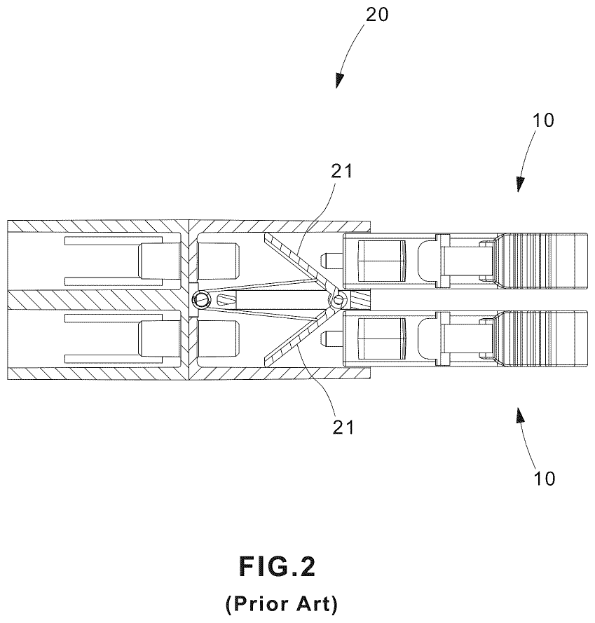

Additionally, an adapter for hybrid fiber and electrical connectors should incorporate shutters, similar to the shutters 21 included in the fiber optic adapter 20 shown in FIG. 2. The shutters 21 are designed to serve a dual purpose: preventing the ingress of dust and debris while safeguarding the eyes of workers or technicians involved in installing or maintaining a fiber optic system. This protective function shields them from potential harm caused by the light emitted from uncovered connectors, a concept outlined in U.S. Pat. No. 9,709,754 assigned to Panduit Corp., the entirety of which is hereby incorporated by reference herein.

In this disclosure, a solution is provided in the form of a hybrid cable connector and adapter assembly system that utilizes a vertically stacked connector design for its outstanding electrical connectivity and compact dimensions.

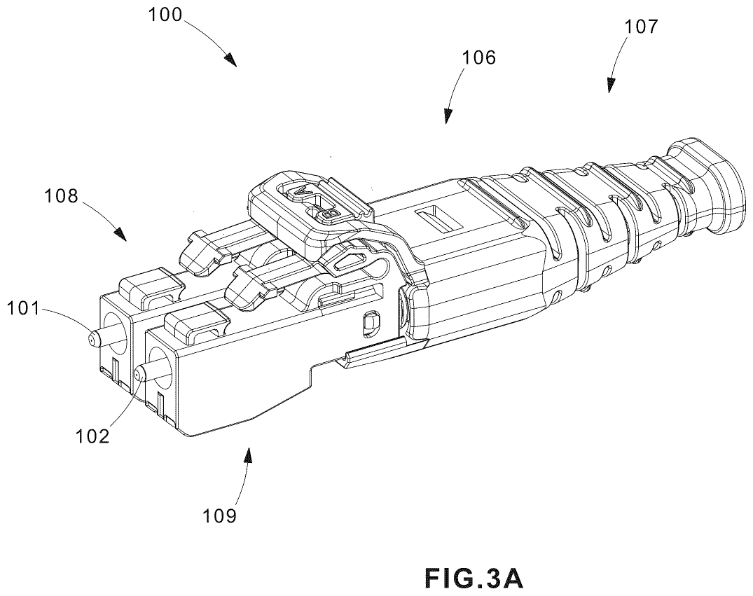

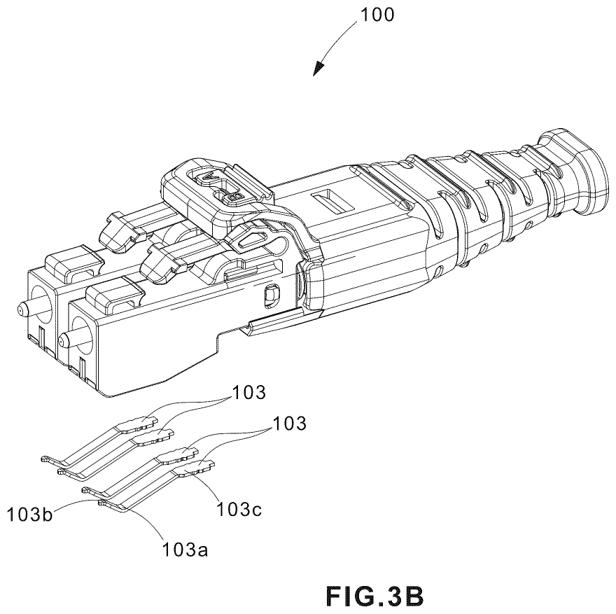

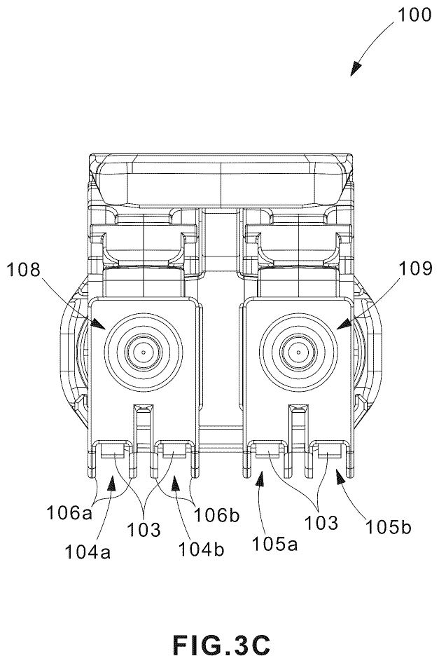

FIG. 3A shows a duplex hybrid connector 100, according to an exemplary embodiment. The duplex hybrid connector 100 is shown in the LC fiber optic connector form factor for exemplary purposes. However, the fiber optic connector form factor may take on other forms such as, but not limited to, SC, SN, CN, or MPO fiber connectors. The duplex hybrid connector 100 is comprised of a first connector 108 and a second connector 109, where both the first connector 108 and the second connector 109 fit into a push-pull clip holder 106, and a flexible boot 107.

As shown in FIG. 3B, the duplex hybrid connector 100 includes conductive leaf springs 103 installed within a bottom portion of the first connector 108 and the second connector 109. More specifically, FIG. 3C shows a front side view of the duplex hybrid connector 100 that shows the conductive leaf springs 103 installed into recessed channels 104a, 104b at the bottom portion of the first connector 108, and within recessed channels 105a, 105b at the bottom portion of the second connector 109. The recessed channels 104a, 104b are formed, at least in part, by insulative protector walls 106a, 106b that cover and protect the conductive leaf springs 103 from human contact. The pair of conductive leaf springs 103 installed into the recessed channels 105a, 105b of the second connector 109 also include the same insulative protector walls. The insulative protector walls 106a, 106b may have a height and length such that the recessed channels 104a, 104b have a height of approximately 0.11 inch (2.8 mm) or higher, and a length of approximately 0.454 inch (11.5 mm) or longer.

The leaf springs 103 may have a thickness of approximately 0.01 inch (0.25 mm) and a width of 0.36 inch (0.9 mm). The leaf springs 103 may include a flat top 103c configured to connect with a conductor running within the duplex hybrid connector 100 that carries the electrical signal from the conductive wires of the hybrid cable coupled to the duplex hybrid connector 100.

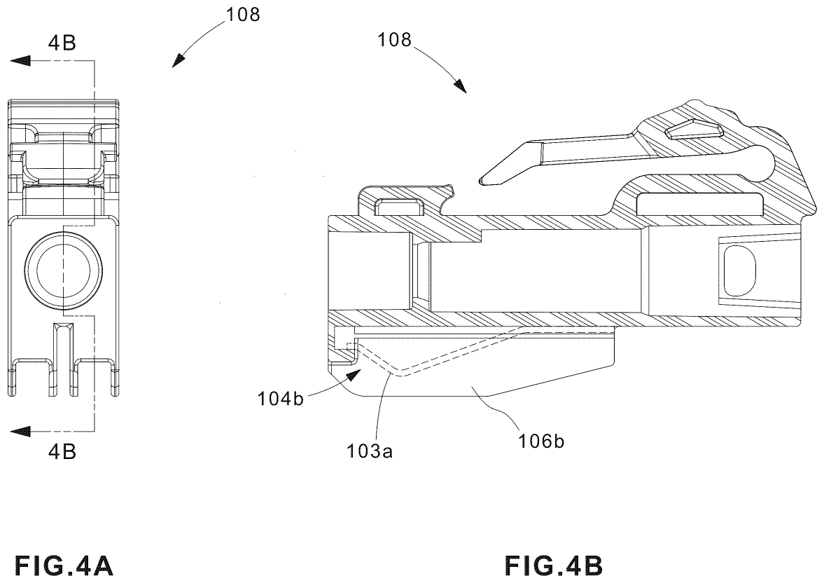

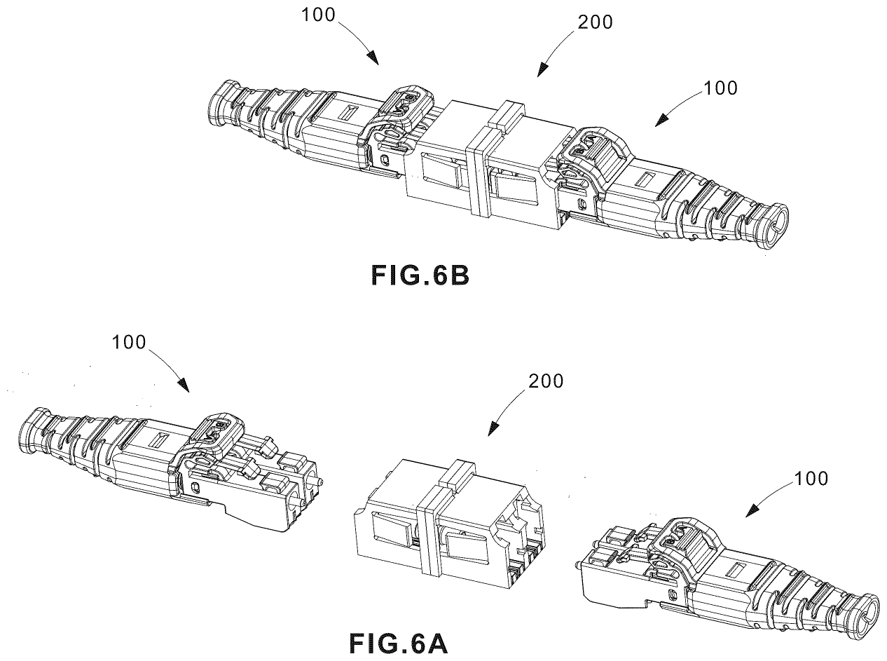

The leaf springs also include a front tip 103b, and an angled protrusion 103a that is raised from a bottom surface of the recessed channels 104a, 104b. When the duplex hybrid connector 100 is installed into a corresponding duplex hybrid adapter 200, as shown in FIG. 6B, the angled protrusions 103a are raised to come into contact with conductive plates 230a, 230b installed within the duplex hybrid adapter 200. FIG. 4A shows a front side view of the first connector 108, and FIG. 4B shows a cross-sectional view of the first connector 108 taken along the line 4B-4B that illustrates how the angled protrusion 103a raises up from a bottom surface of the recessed channel 104b while still staying below the height of the insulative protector wall 106b.

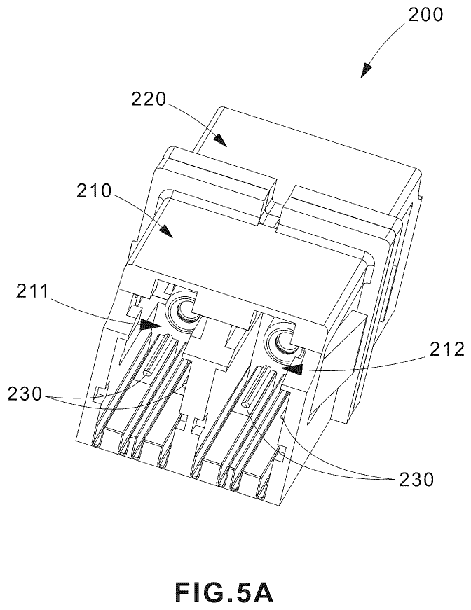

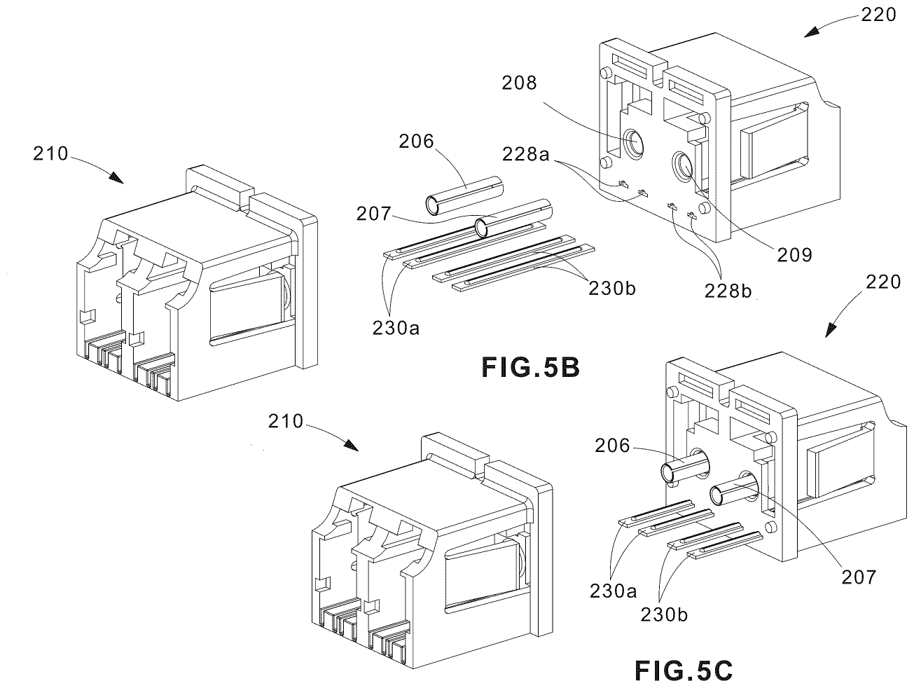

FIG. 5A shows a duplex hybrid adapter 200, into which the duplex hybrid connector 100 may be installed, according to an exemplary embodiment. The duplex hybrid adapter 200 includes a hybrid adapter body comprising a first half 210 for installing a first duplex hybrid connector 100, and a second half 220 for installing a second duplex hybrid connector 100. The first half 210 includes a first opening 212 for receiving, for example, the first connector 108, and a second opening 211 for receiving, for example, the second connector 109 in the duplex hybrid connector 100.

As shown in the exploded views of the duplex hybrid adapter 200 in FIG. 5B-5C, the duplex hybrid adapter 200 also includes a pair of fiber tunnels 206, 207 for transmitting a fiber optic signal from the duplex hybrid connector 100 in the first half 210 to the duplex hybrid connector 100 installed at the second half 220. More specifically, a first fiber tunnel 207 transmits a fiber optic signal from the first connector 108 installed at the first side 210 to an opposite side connector installed at the second side 220, and a second fiber tunnel 206 transmits a fiber optic signal from the second connector 109 installed at the first side 210 to another opposite side connector installed at the second side 220, where the two connectors on the second side 220 together comprise an opposite side duplex hybrid connector 100, same as the duplex hybrid connector 100 installed at the first side 210. There are also fiber tunnel holes 208, 209 for installing the fiber tunnels 206, 207.

For transmitting an electrical power transmission from the duplex hybrid connector 100 installed at the first side 210 to the opposite side duplex hybrid connector 100 installed at the second side 220, the duplex hybrid adapter 200 includes two pairs of conductive plates 230a, 230b positioned at the bottom of the adapter housing in both the first half 210 and the second half 220. A first pair of conductive plates 230b is electrically coupled (e.g., contacts) to the pair of leaf springs 103 installed on the first connector 108 inserted into the first half 210 of the duplex hybrid adapter 200, and a pair of leaf springs 103 installed at a corresponding opposite side connector at the second half 220. Similarly, a second pair of conductive plates 230a is electrically coupled (e.g., contacts) to the pair of leaf springs 103 installed on the second connector 108 inserted into the first half 210 of the duplex hybrid adapter 200 and a second pair of leaf springs installed at a corresponding opposite side connector at the second half 220, where the two corresponding opposite side connectors inserted into the second half 220 together comprise another duplex hybrid connector 100, as shown in FIGS. 6A and 6B. The conductive plates 230a, 230b are installed into bottom tunnels 228a, 228b.

The conductive plate 230a, 230b may have a length of approximately 0.548 inch (13.9mm), a width of approximately 0.043 inch (1.1 mm), and a thickness of approximately 0.01 inch (0.25 mm).

FIG. 6A shows a perspective view of the duplex hybrid connector 100 and the opposite side duplex adapter 100 prior to being installed into the duplex hybrid adapter 200. FIG. 6B shows a perspective view of the duplex hybrid connector 100 and the opposite side duplex adapter 100 installed into the duplex hybrid adapter 200 in an installed state. When the duplex hybrid connectors 100 are installed into both halves 210, 220 of the duplex hybrid adapter 200, there is good contact between the conductive leaf springs 103 included in the duplex hybrid connectors 100 and the conductive plates 230a, 230b included in the duplex hybrid adapter 200, so that an electrical power signal from the duplex hybrid connector 100 installed into the first side 210 of the duplex hybrid adapter 200 can be transferred through the duplex hybrid adapter 200 to the opposite side duplex hybrid connector 100 installed into the second side 220.

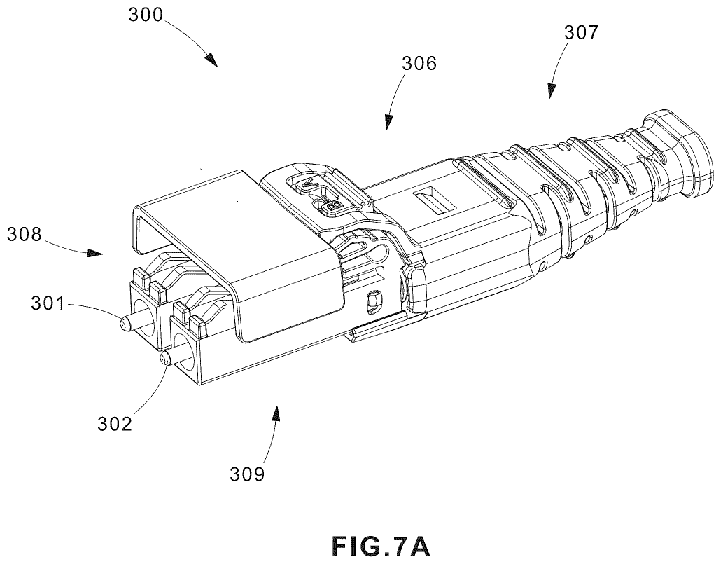

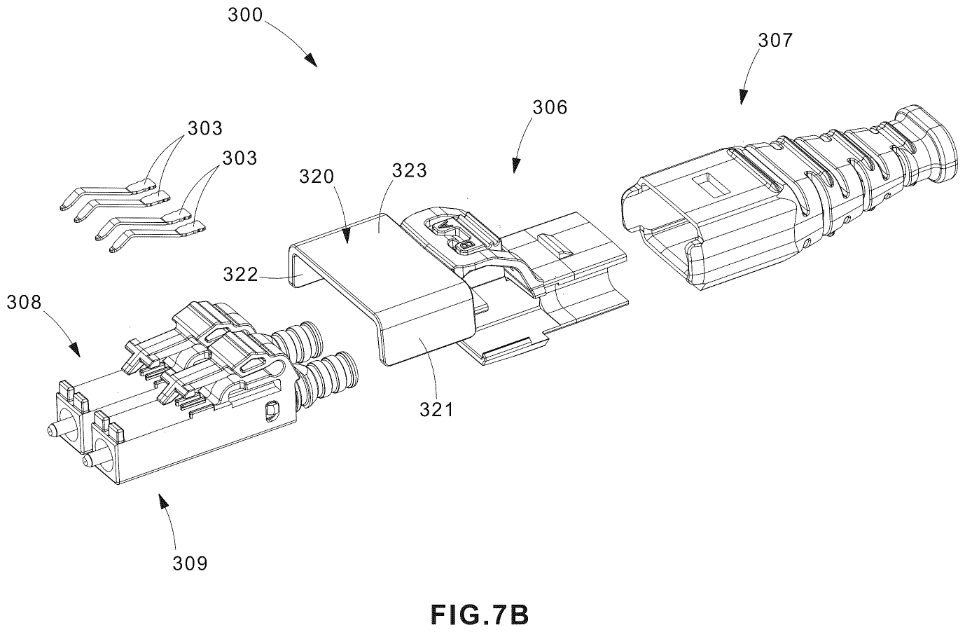

FIG. 7A shows a perspective view of an exemplary duplex hybrid connector 300, according to an alternative embodiment. Similar to the duplex hybrid connector 100 shown in FIG. 3A, the present duplex hybrid connector 300 is also comprised of a first connector 308 and a second connector 309. The duplex hybrid connector 300 also includes a flexible boot 307, and a push-pull clip 306. Unlike the previous duplex hybrid connector 100 that included leaf springs 103 on a bottom portion, the current duplex hybrid connector 300 includes conductive leaf springs 303 at a top portion of the first connector 308 and the second connector 309. The shape and components of the leaf springs 303 may be the same as the components of the leaf spring 103 described above.

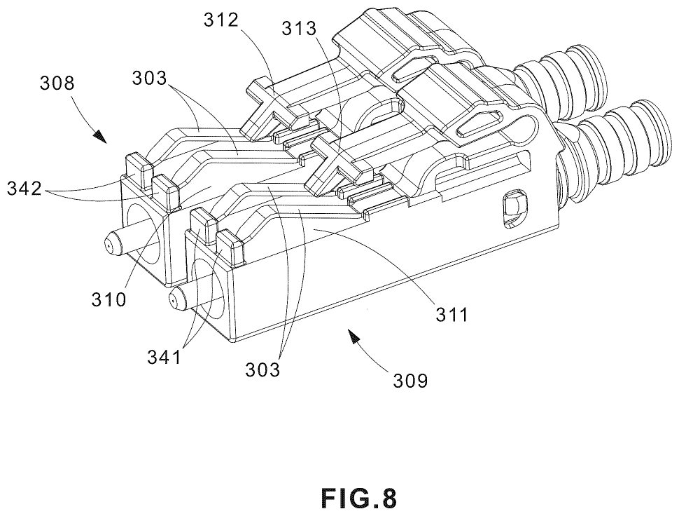

As shown in FIG. 7B, the push-pull clip 306 includes an insulative protector 320 for covering the leaf springs 303 that are installed onto the top portion of the first connector 308 and the second connector 309. As further seen in FIG. 8, the leaf springs 303 are positioned on a top portion of the first connector 308 and the second connector 309, adjacent to a latch first latch 312 and a second latch 313 that are also included on the top portion of the first connector 308 and the second connector 309, respectively. The top portion of the first connector 308 and the second connector 309 also include stops 341, 342 for abutting against a front tip to the leaf springs 303.

For example, the stops 342 protrude up from the top surface 310 of the first connector 308 to abut against the front tip of the pair of leaf springs 303 that are installed onto the top surface 310 of the first connector 308 to prevent the leaf springs 303 from falling out. Similarly, the stops 341 protrude up from the top surface 311 of the second connector 309 to abut against the front tip of the pair of leaf springs 303 that are installed onto the top surface 311 of the second connector 309 to prevent the leaf springs 303 from falling out.

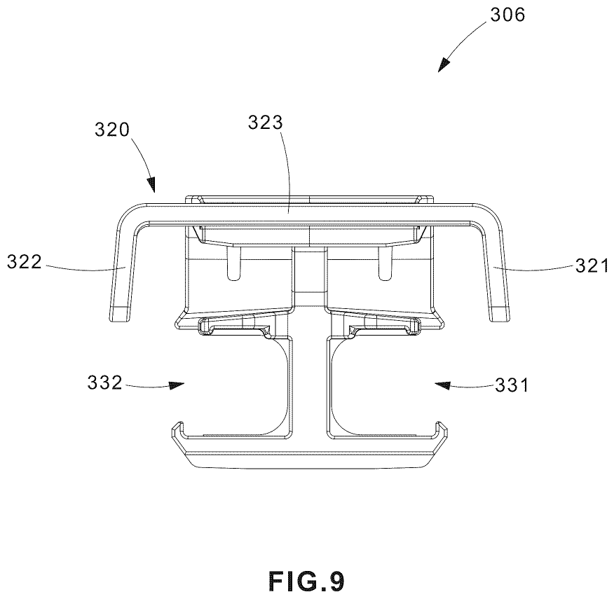

To ensure electrical safety, the leaf springs 303 are shielded by the insulative protector 320 to prevent user contact. As seen in FIG. 9, the insulative protector 320 is included as part of the push-pull clip 306, and includes a top cover 323 and side walls 322, 321 that come down off opposite sides of the top cover 323. The push-pull clip 306 also includes a first cavity 332 for holding the first connector 308 and a second cavity 331 for holding the second connector 309.

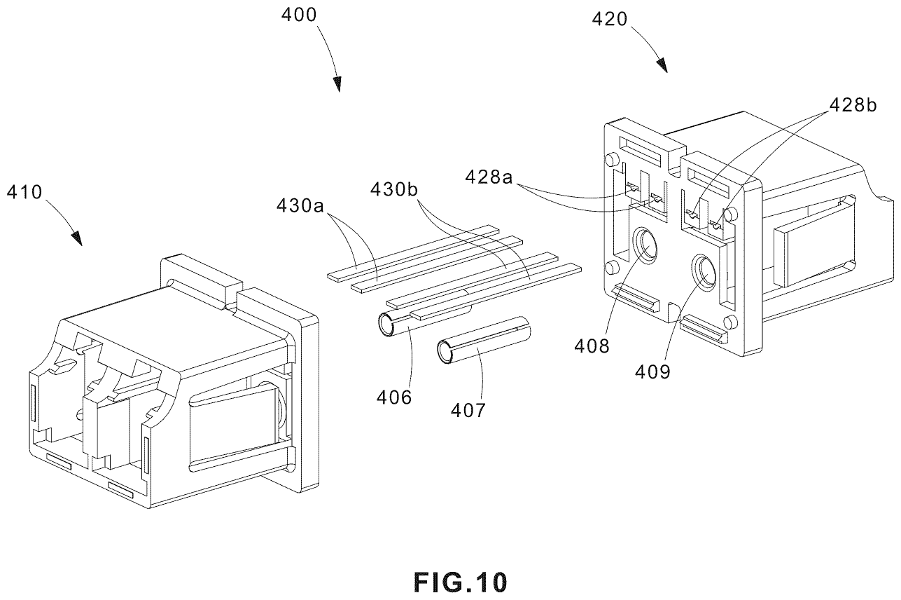

FIG. 10 shows an exploded perspective view of a duplex hybrid adapter 400, according to the alternative embodiment, where the duplex hybrid adapter 400 is configured to have the duplex hybrid connector 300 installed within it according to the alternative embodiment. To enable the transmission of electrical power, the duplex hybrid adapter 400 includes conductive plates 430a, 430b installed into a top portion of the housing to the duplex hybrid adapter 400.

More specifically, the duplex hybrid adapter 400 includes a hybrid adapter body comprising a first half 410 and a second half 420. The duplex hybrid adapter 400 also includes features such as a pair of fiber tunnels 406, 407 for transmitting a fiber optic signal from the duplex hybrid connector 300 installed into the first half 410 to the duplex hybrid connector 300 installed into the second half 420. So a first fiber tunnel 407 transmits a fiber optic signal from the first connector 308 installed at the first half 410 to an opposite side connector installed at the second half 420, and a second fiber tunnel 406 transmits a fiber optic signal from the second connector 309 installed at the first half 410 to another opposite side connector installed at the second half 420, where the two opposite side connectors installed into the second half 420 together comprise an opposite side duplex hybrid connector 300. There are also fiber tunnel holes 408, 409 for installing the fiber tunnels 406, 407.

For transmitting an electrical power transmission from the duplex hybrid connector 300 installed at the first half 410 to the opposite side duplex hybrid connector 300 installed at the second half 420, the duplex hybrid adapter 400 includes two pairs of conductive plates 430a, 430b installed into the top portion of the first half 410 and the second half 420, as seen in FIG. 10. There are also top tunnels 428a, 428b for installing the conductive plates 430a, 430b. A first pair of conductive plates 430b is electrically coupled (e.g., contacts) to the first pair of leaf springs 303 installed onto the top surface 310 of the first connector 308 at the first half 410 of the duplex hybrid adapter 400, and to a pair of leaf springs 303 installed at a corresponding connector in the opposite side duplex hybrid connector 300 installed at the second half 420. Similarly, a second pair of conductive plates 430a is electrically coupled (e.g., contacts) to the pair of leaf springs 303 installed on the top surface 311 of the second connector 309 installed at the first half 410 of the duplex hybrid adapter 400, and to a pair of leaf springs 303 installed at a corresponding connector in the opposite side duplex hybrid connector 300 installed at the second half 420.

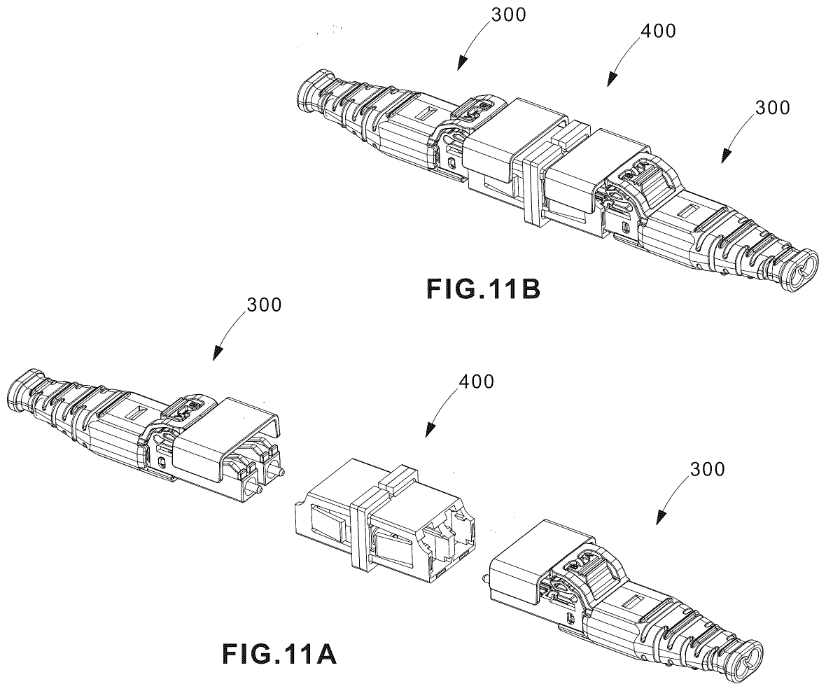

FIG. 11A shows a perspective view of the duplex hybrid connector 300 and the opposite side duplex adapter 300 prior to being installed into the duplex hybrid adapter 400. FIG. 11B shows a perspective view of the duplex hybrid connector 300 and the opposite side duplex adapter 300 installed into the duplex hybrid adapter 400 in an installed state. When the duplex hybrid connectors 300 is installed into the duplex hybrid adapter 400, there is good contact between the conductive leaf springs 303 included in the duplex hybrid connectors 300 and the conductive plates 430a, 430b included in the duplex hybrid adapter 400, so that an electrical power signal from the duplex hybrid connector 300 installed into the first half 410 of the duplex hybrid adapter 300 can be transferred through the duplex hybrid adapter 400 to the opposite side duplex hybrid connector 300 installed into the second half 420.

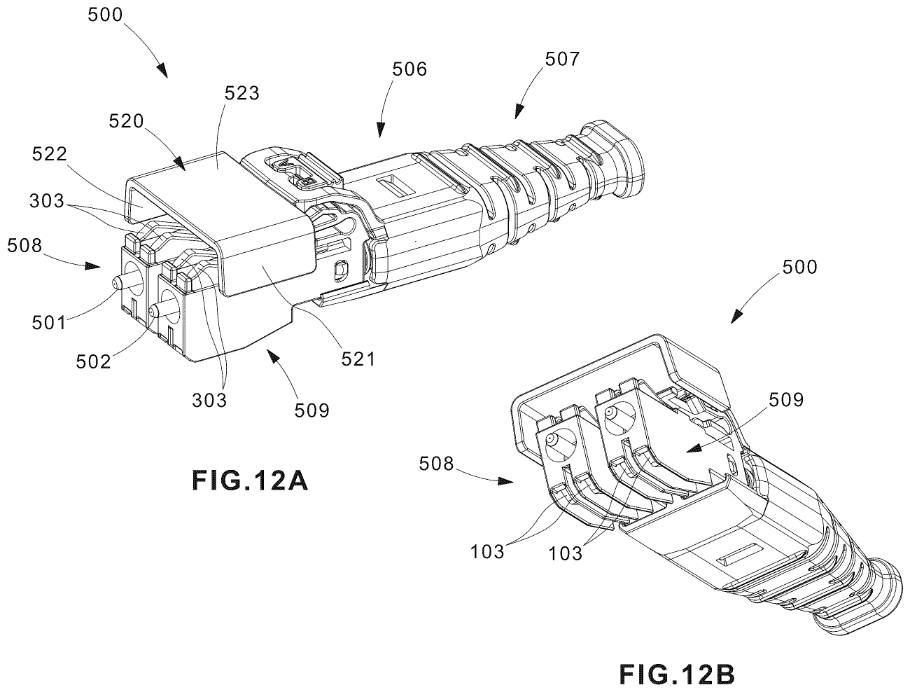

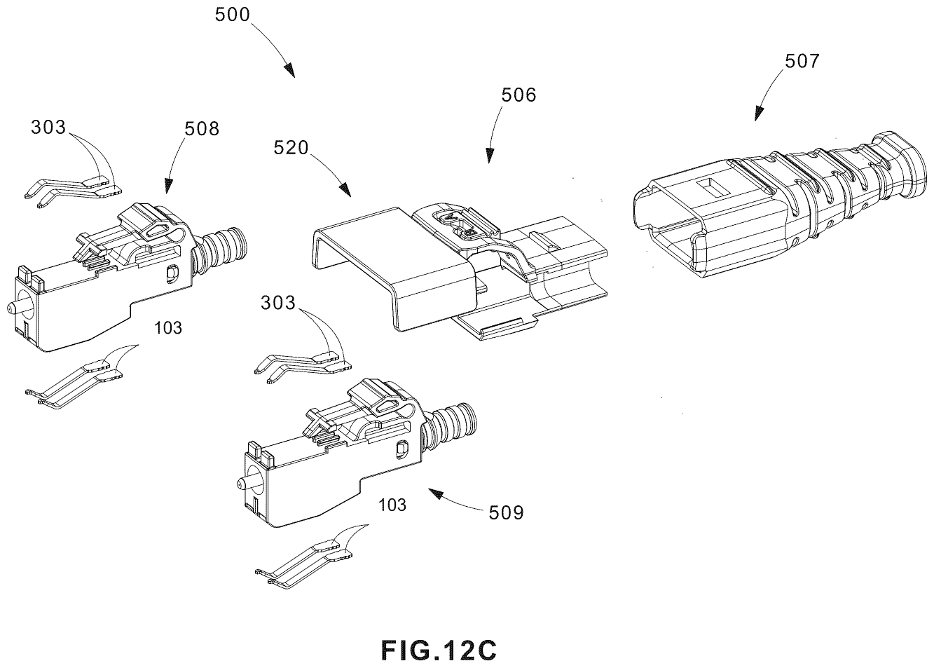

FIG. 12A shows a top-down perspective view of an exemplary duplex hybrid connector 500, where the duplex hybrid connector 500 incorporates features from both the duplex hybrid connectors 100 and 300 described previously, according to an alternative embodiment. FIG. 12B shows a bottom-up perspective view of the duplex hybrid connector 500. While sharing many of the same components as previously described in the duplex hybrid connectors 100 and 300, the present duplex hybrid connector 500 includes the conductive leaf springs 103 both at the bottom and top portions of the duplex hybrid connector 500.

The duplex hybrid connector 500 includes a first connector 508 and a second connector 509. As shown in FIG. 12A, a pair of leaf springs 303 are included at a top portion of the first connector 508, and a pair of leaf springs 303 are included at a top portion of the second connector 509. As shown in FIG. 12B, a pair of leaf springs 103 are included in a recessed channel at a bottom portion of the first connector 508, and a pair of leaf springs 103 are included in a recessed channel at a bottom portion of the second connector 509.

The duplex hybrid connector 500 includes a boot 507, a push-pull clip 506, and fiber ferrules 501, 502. As shown in FIG. 12C, the push-pull clip 506 includes an insulative protector 520 that includes a top cover 523 and side walls 522, 521 that come down off opposite sides of the top cover 523. The insulative protector 520 is configured to cover the leaf springs 303 that are included at the top portion of the first connector 508 and the top portion of the second connector 509.

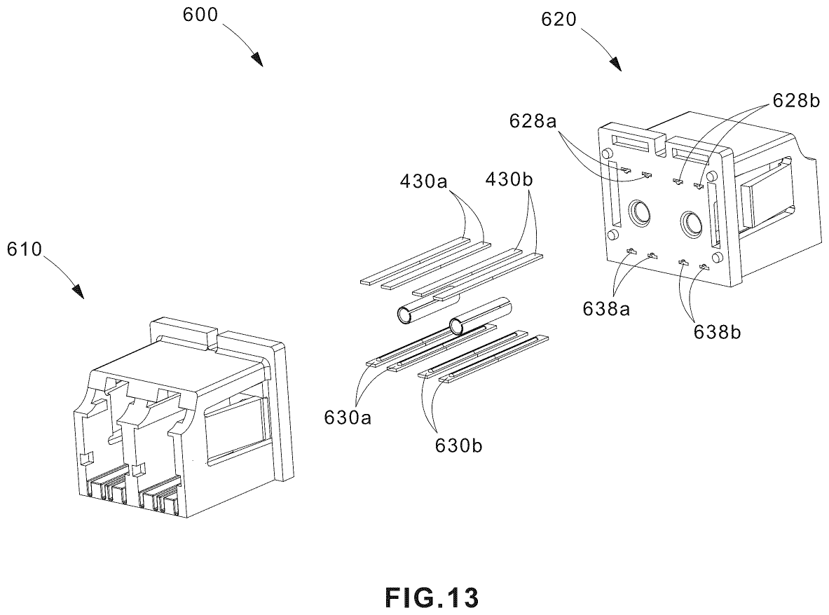

FIG. 13 shows a duplex hybrid adapter 600 configured to install the LC duplex hybrid connector 300, according to the alternative embodiment, where there includes both two pairs of top conductive plates 430a, 430b and two pairs of bottom conductive plates 630a, 630b. There are top tunnels 628a, 628b for installing the top conductive plates 430a, 430b, and bottom tunnels 638a, 638b for installing the bottom conductive plates 630a, 630b. The duplex hybrid adapter 600 includes a first half 610 and a second half 620.

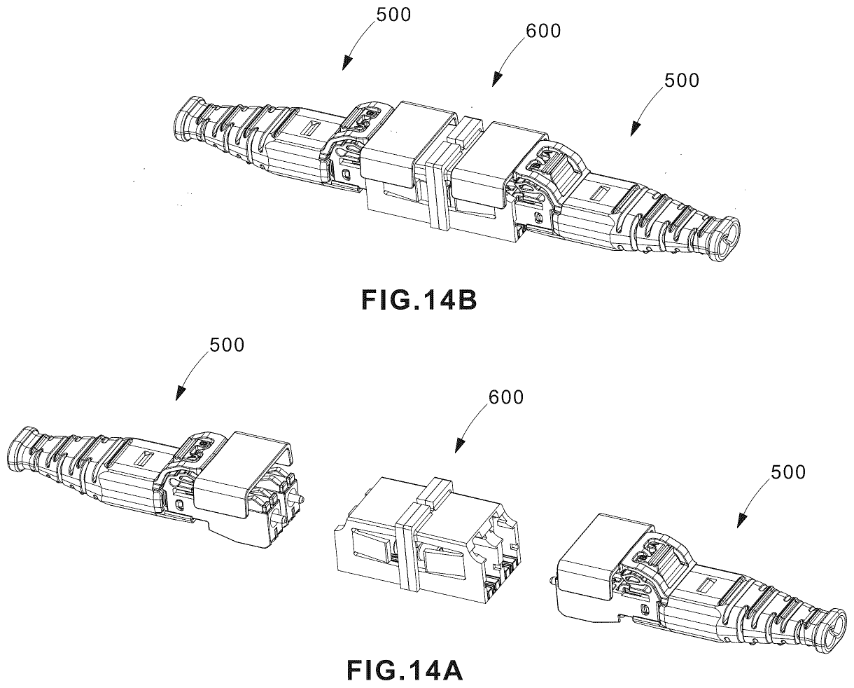

FIG. 14A shows a perspective view of the duplex hybrid connector 500 and an opposite side duplex hybrid connector 500 prior to being installed into the duplex hybrid adapter 600. FIG. 14B shows a perspective view of the duplex hybrid connector 500 and the opposite side duplex hybrid connector 500 installed into the duplex hybrid adapter 600 in an installed state.

When the duplex hybrid connector 500 is inserted into the LC duplex hybrid adapter 600, there is good contact between the leaf springs 303 and the top conductive plates 430a, 430b, and the leaf springs 103 and the bottom conductive plates 630a, 630b, so that electrical power from the duplex hybrid connector 500 installed into the first half 610 of the duplex hybrid adapter 600 can be transferred to the opposite side duplex hybrid connector 500 installed into the second half 620 of the duplex hybrid adapter 600. Unlike previously described embodiments, the duplex hybrid connector 500 and the duplex hybrid adapter 600 shown in FIG. 14B provides twice the electrical channels and twice the total power.

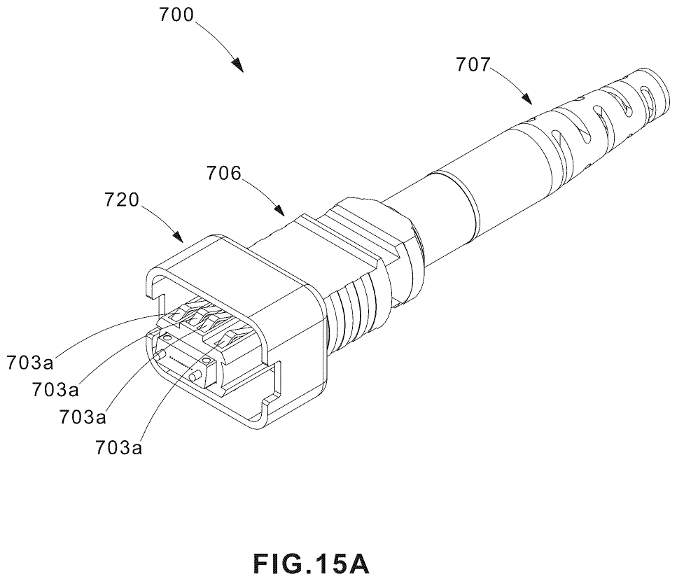

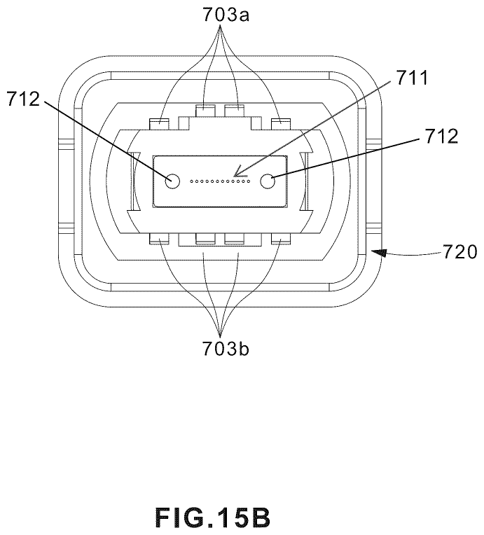

FIG. 15A shows a perspective view of an exemplary hybrid connector 700, according to an alternative embodiment. The hybrid connector 700 takes on the basic form factor of an MPO fiber connector. For example, as shown by the front-side view of the hybrid connector 700 in FIG. 15B, the hybrid connector 700 includes a line of fiber ferrules 711 and pins 712. The hybrid connector 700 may include, for example, twelve, twenty four, or other number of fiber ferrules 711 found in an existing MPO fiber connector. The hybrid connector 700 also includes a boot, a housing 706, and an insulative protector 720.

Also included in the hybrid connector 700 are top conductive leaf springs 703a and bottom conductive leaf springs 703b. The top leaf springs 703a include four total (i.e., two pairs), and the bottom leaf springs 703b include four total (i.e., two pairs). The insulative protector 720 may wrap around the top leaf springs 703a and the bottom leaf springs 703b.

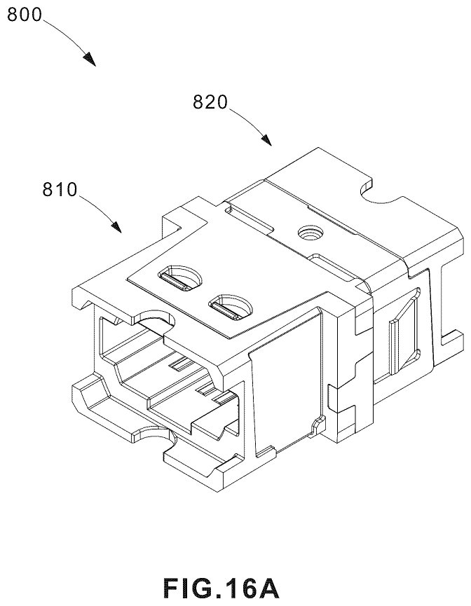

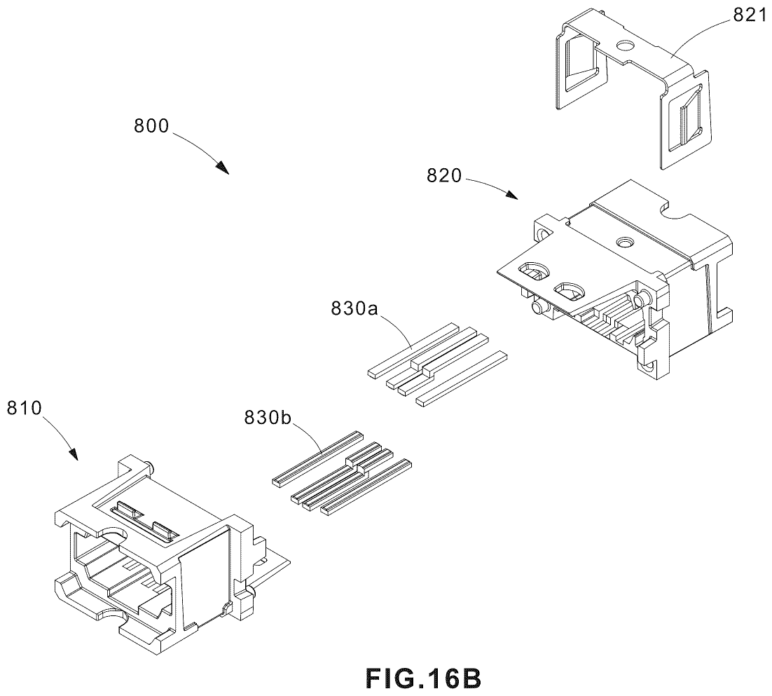

FIG. 16A shows an exemplary hybrid adapter 800 configured to receive the hybrid connector 700, according to the alternative embodiment. The hybrid adapter 800 includes a first half 810 and a second half 820.

FIG. 16B shows an exploded view of the hybrid adapter 800. The hybrid adapter 800 includes a cover 821, top conductive plates 830a, and bottom conductive plates 830b. The top conductive plates 830a and the bottom conductive plates 830b are housed to be partially in both the first half 810 and the second half 820 to assist in the transmission of an electrical signal from the first half 810 to the second half 820.

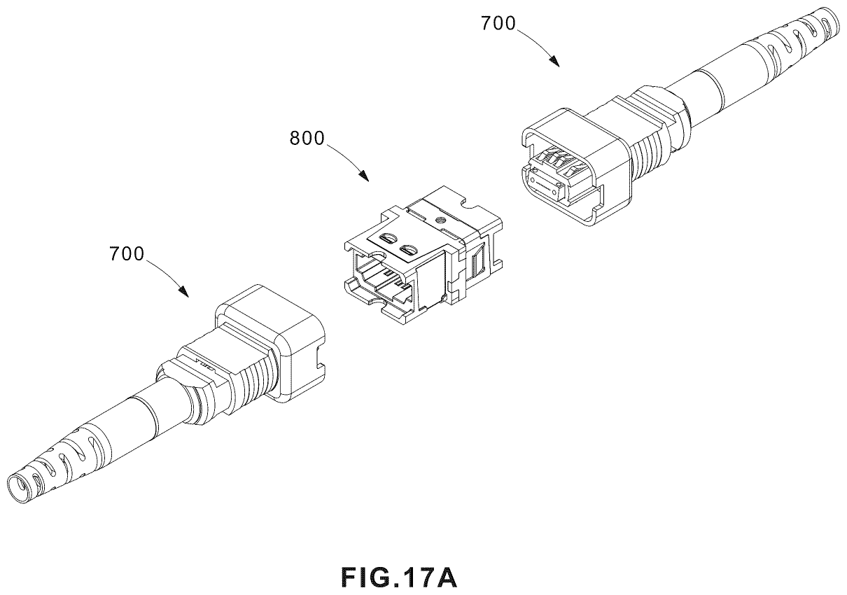

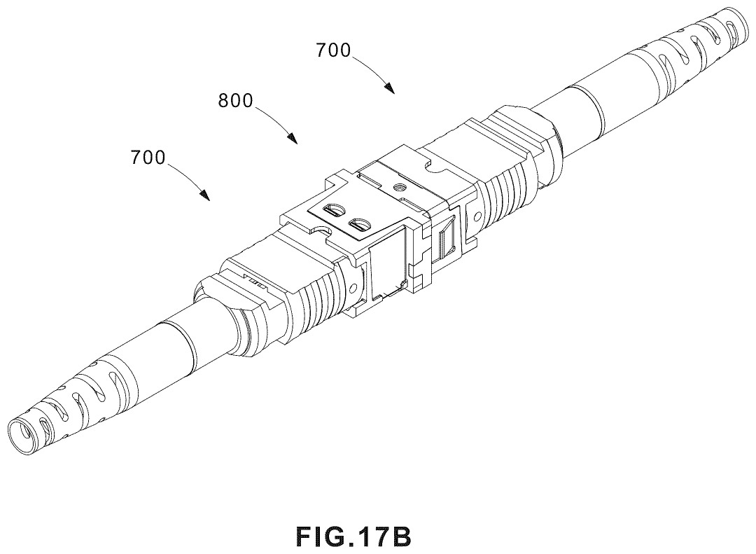

FIG. 17A shows the hybrid connector 700 and an opposite side hybrid connector 700 prior to being installed into the hybrid adapter 800. FIG. 17B shows the hybrid connector 700 and the opposite side hybrid connector 700 installed into the hybrid adapter 800 in an installed state. When the hybrid connector 700 is inserted into the hybrid adapter 800, there is good contact between the top leaf springs 703a and the top conductive plates 830a, as well as good contact between the bottom leaf springs 703b and the bottom conductive plates 830b, so that electrical power from the hybrid connector 700 installed into the first half 810 may be effectively transferred through the hybrid adapter 800 to the opposite side hybrid connector 700 installed into the second half 820.

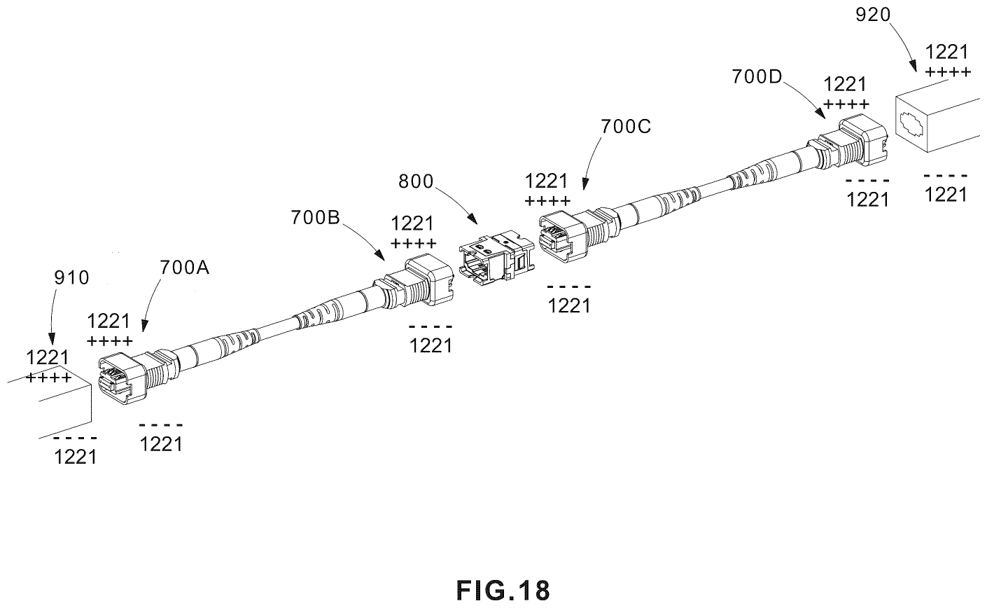

When managing the fiber and electrical signal connections of a hybrid connector, the issue of maintaining proper polarity for both the fiber and electrical wires is a concern. There are two main connections methods when it comes to polarity of fiber: Method A and Method B. FIG. 18 shows a perspective view of an exemplary connection system configured to transmit and receive both optical and electrical signals between a first transceiver 910 and a second transceiver 920 using the hybrid connectors 700A, 700B, 700C, 700D and the hybrid adapter 800, where the hybrid connectors 700A, 700B, 700C, 700D are instances of the hybrid connector 700 described herein. As illustrated in FIG. 18, the hybrid connectors 700A, 700B, 700C, 700D and the hybrid adapter 800 are assumed to be configured in a Method B arrangement using key up to key up (Position 1 arrives at Position 12) to ensure proper fiber transmission where the transmission (Tx) fiber ferrules are lined up to the correct corresponding receiving fiber ferrules between the fiber ferrules provided on the MPO type hybrid connectors 700A, 700B, 700C, 700D.

Regarding the transmission of an electrical power signal between the first transceiver 910 and the second transceiver 920, the polarity arrangement enabled by the four top leaf springs 703a and four bottom leaf springs 703b in the hybrid connectors 700A, 700B, 700C, 700D may be connected through the hybrid adapter 800 as shown in FIG. 18. FIG. 18 shows a centrosymmetric setup for two electrical channels (channel 1 and channel 2, each channel having a positive (+) and negative (−) polarity) using eight total electrodes corresponding to the four top leaf springs 703a and four bottom leaf springs 703b. In this configuration shown in FIG. 18, the four pairs of electrodes have a short circuit between the two central pairs and another between the two side pairs. With this centrosymmetric setup, electrical channel one from the first transceiver 910 correctly connects to electrical channel one from the second transceiver 920, ensuring proper directionality and functionality.

The conductive leaf springs and the conductive plates described herein may be made from an electrically conductive metal material.

According to this disclosure, a hybrid fiber and electrical connector and adapter system comprising two simplex fiber optic connectors and a simplex fiber optic adapter is disclosed, wherein the two fiber optic connectors can be connected to each other via the fiber optic adapter, wherein the fiber optic connectors have at least one conductor at the bottom of the connector, whereby at least one conductor at the bottom of the connector is aligned to contact the conductor in the fiber optic adapter, wherein the fiber optic adapter has at least one conductor at the bottom of the adapter housing and is aligned to contact at least one conductor of both the fiber optic connectors at each side, wherein at least two vertical insulative protectors are located at both sides of the conductor at the bottom of the connector. The vertical insulative protectors are taller than the connector's conductor so that the connector's conductor is recessed between two insulative protectors to prevent the user from touching the conductor on the connector while allowing the conductor's conductor to contact the adapter's conductor when the connector is inserted into the adapter.

Also disclosed is the hybrid fiber and electrical connector and adapter system, wherein the conductors at the bottom of the connectors are flat conductive plates, and the conductor in the adapter is a conductive leaf spring.

Also disclosed is the hybrid fiber and electrical connector and adapter system, wherein the conductive leaf spring in the adapter has protrusion toward the conductive plates at the bottom of the hybrid connectors to allow good contact and provide a normal force between the conductive leaf spring and the conductive plates so that electrical power from the hybrid connector at one side of the hybrid adapter can be transferred to the hybrid connector at the other side of the hybrid adapter.

Also disclosed is the hybrid fiber and electrical connector and adapter system, wherein the conductors at the bottom of the connectors are conductive leaf springs, and the conductor in the adapter is a flat conductive plate.

Also disclosed is the hybrid fiber and electrical connector and adapter system, wherein the conductive leaf springs at the bottom of the connector have protrusion toward the conductive plate in the adapter to allow good contact and provide a normal force between the conductive leaf springs and the conductive plate so that electrical power from the hybrid connector at one side of the adapter can be transferred to the hybrid connector at the other side of the hybrid adapter.

Also disclosed is the hybrid fiber and electrical connector and adapter system, wherein the conductors at the bottom of the connectors are connected to conductive sleeves, which can terminate the electrical wires of field cables by crimping.

Also disclosed is the hybrid fiber and electrical connector and adapter system, wherein the conductors at the bottom of the connector are connected to conductive sleeves, which can terminate the electrical wires of field cables by tightening the screw on the conductive sleeves.

Also disclosed is the hybrid fiber and electrical connector, wherein the fiber optic connector features a stub fiber with one pre-polished end at the fiber optic connector's endface. In contrast, the stub fiber's other end can be seamlessly connected to a field fiber to install a fiber optic connector on a fiber optic cable.

Also disclosed is the hybrid fiber and electrical adapter, wherein the hybrid adapter has at least one shutter to prevent the ingress of dust and debris while safeguarding the eyes of workers or technicians involved in the installation or maintenance of a fiber optic system.

Also disclosed is the hybrid fiber and electrical connector and adapter system, wherein the hybrid fiber and electrical connectors and adapter system can be installed on a patch panel or in a cassette.

Disclosed is a hybrid fiber and electrical connector and adapter system comprising two duplex fiber optic connectors and a duplex fiber optic adapter, wherein the two pairs of fiber optic connectors can be connected to each other via the duplex fiber optic adapter, wherein the fiber optic connectors have at least one conductor at the bottom of the connector, whereby at least one conductor at the bottom of the connector is aligned to contact the conductor in the fiber optic adapter, wherein the fiber optic adapter has at least one conductor at the bottom of the adapter housing and is aligned to contact at least one conductor of both the fiber optic connectors at each side, wherein at least two vertical insulative protectors are located at both sides of the conductor at the bottom of the connector. The vertical insulative protectors are taller than the connector's conductor so that the connector's conductor is recessed between two insulative protectors to prevent the user from touching the conductor on the connector while allowing the conductor's conductor to contact the adapter's conductor when the connector is inserted into the adapter.

Also disclosed is the hybrid fiber and electrical connector and adapter system, wherein the conductors at the bottom of the hybrid connectors are flat conductive plates, and the conductor in the adapter is a conductive leaf spring.

Also disclosed is the hybrid fiber and electrical connector and adapter system, wherein the conductive leaf spring in the adapter has protrusion toward the conductive plates at the bottom of the hybrid connectors to allow good contact and provide a normal force between the conductive leaf spring and the conductive plates so that electrical power from the hybrid connector at one side of the adapter can be transferred to the hybrid connector at the other side of the adapter.

Also disclosed is the hybrid fiber and electrical connector and adapter system, wherein the conductors at the bottom of the connectors are conductive leaf springs, and the conductor in the hybrid adapter is a flat conductive plate.

Also disclosed is the hybrid fiber and electrical connector and adapter system, wherein the conductive leaf springs at the bottom of the connectors have protrusion toward the conductive plate in the adapter to allow good contact and provide a normal force between the conductive leaf springs and the conductive plate so that electrical power from the connector at one side of the adapter can be transferred to the connector at the other side of the adapter.

Also disclosed is the hybrid fiber and electrical connector and adapter system, wherein the conductors at the bottom of the connectors are connected to conductive sleeves, which can terminate the electrical wires of field cables by crimping.

Also disclosed is the hybrid fiber and electrical connector and adapter system, wherein the conductors at the bottom of the connectors are connected to conductive sleeves, which can terminate the electrical wires of field cables by tightening the screw on the conductive sleeves.

Also disclosed is the hybrid fiber and electrical connector, wherein the fiber optic connector features a stub fiber with one pre-polished end at the fiber optic connector's endface. In contrast, the stub fiber's other end can be seamlessly connected to a field fiber to install a fiber optic connector on a fiber optic cable.

Also disclosed is the hybrid fiber and electrical adapter, wherein the hybrid adapter has at least a pair of shutters to prevent the ingress of dust and debris while safeguarding the eyes of workers or technicians involved in the installation or maintenance of a fiber optic system.

Also disclosed is the hybrid fiber and electrical connector and adapter system, wherein the hybrid fiber and electrical connectors and adapter system can be installed on a patch panel or in a cassette.

Disclosed is a hybrid LC fiber and electrical connector and adapter system comprising two simplex LC fiber optic connectors and a simplex LC fiber optic adapter, wherein the two fiber optic connectors can be connected to each other via the fiber optic adapter, wherein the fiber optic connectors have at least one conductor on the top of the connector housing, close to the connector latch, whereby at least one conductor is aligned to contact the conductor in the fiber optic adapter, wherein the fiber optic adapter has at least one conductor at the top of the adapter housing, close to the latch, and is aligned to contact at least one conductor of both the fiber optic connectors at each side, wherein an insulative protector is attached to the top of the connector to protect the user from touching the conductor on the connector, and a gap exists between the protector and the conductor on the hybrid connector to allow it to be inserted into the hybrid adapter.

Also disclosed is the hybrid fiber and electrical connector and adapter system, wherein the conductor on the top of the hybrid connector is a flat conductive plate, and the conductor in the hybrid adapter is a conductive leaf spring.

Also disclosed is the hybrid fiber and electrical connector and adapter system, wherein the conductive leaf spring in the hybrid adapter has protrusion toward the conductive plate at the bottom of the hybrid connector to allow good contact and provide a normal force between the conductive leaf spring and the conductive plate so that electrical power from the hybrid connector at one side of the hybrid adapter can be transferred to the hybrid connector at the other side of the hybrid adapter.

Also disclosed is the hybrid fiber and electrical connector and adapter system, wherein the conductor at the bottom of the hybrid connector is a conductive leaf spring, and the conductor in the hybrid adapter is a flat conductive plate.

Also disclosed is the hybrid fiber and electrical connector and adapter system, wherein the conductive leaf spring at the bottom of the hybrid connector has protrusion toward the conductive plate in the hybrid adapter to allow good contact and provide a normal force between the conductive leaf spring and the conductive plate so that electrical power from the hybrid connector at one side of the hybrid adapter can be transferred to the hybrid connector at the other side of the hybrid adapter.

Also disclosed is the hybrid fiber and electrical connector and adapter system, wherein the conductor at the bottom of the connector housing is connected to a conductive sleeve, which can terminate the electrical wire of a field cable by crimping.

Also disclosed is the hybrid fiber and electrical connector and adapter system, wherein the conductor at the bottom of the connector housing is connected to a conductive sleeve which can terminate the electrical wire of a field cable by tightening the screw on the conductive sleeve.

Also disclosed is the hybrid fiber and electrical connector, wherein the fiber optic connector features a stub fiber with one pre-polished end at the fiber optic connector's endface. In contrast, the stub fiber's other end can be seamlessly connected to a field fiber to install a fiber optic connector on a fiber optic cable.

Also disclosed is the hybrid fiber and electrical adapter, wherein the hybrid adapter has shutters to prevent the ingress of dust and debris while safeguarding the eyes of workers or technicians involved in the installation or maintenance of a fiber optic system.

Also disclosed is the hybrid fiber and electrical connector and adapter system, wherein the hybrid fiber and electrical connector and adapter system can be installed on a patch panel or in a cassette.

Disclosed is a hybrid LC fiber and electrical connector and adapter system comprising two duplex LC fiber optic connectors and a duplex LC fiber optic adapter, wherein the two pairs of fiber optic connectors can be connected to each other via the fiber optic adapter, wherein the fiber optic connectors have at least one conductor on the top of the connector housing, close to the connector latch, whereby at least one conductor is aligned to contact the conductor in the fiber optic adapter, wherein the fiber optic adapter has at least one conductor at the top of the adapter housing, close to the latch, and is aligned to contact at least one conductor of both the fiber optic connectors at each side, wherein an insulative protector is attached to the top of the connector to protect the user from touching the conductor on the connector, and a gap exists between the protector and the conductor on the hybrid connector to allow it to be inserted into the hybrid adapter.

Also disclosed is the hybrid fiber and electrical connector and adapter system, wherein the conductor at the bottom of the hybrid connector is a flat conductive plate, and the conductor in the hybrid adapter is a conductive leaf spring.

Also disclosed is the hybrid fiber and electrical connector and adapter system, wherein the conductive leaf spring in the hybrid adapter has protrusion toward the conductive plate at the bottom of the hybrid connector to allow good contact and provide a normal force between the conductive leaf spring and the conductive plate so that electrical power from the hybrid connector at one side of the hybrid adapter can be transferred to the hybrid connector at the other side of the hybrid adapter.

Also disclosed is the hybrid fiber and electrical connector and adapter system, wherein the conductor at the bottom of the hybrid connector is a conductive leaf spring, and the conductor in the hybrid adapter is a flat conductive plate.

Also disclosed is the hybrid fiber and electrical connector and adapter system, wherein the conductive leaf spring at the bottom of the hybrid connector has protrusion toward the conductive plate in the hybrid adapter to allow good contact and provide a normal force between the conductive leaf spring and the conductive plate so that electrical power from the hybrid connector at one side of the hybrid adapter can be transferred to the hybrid connector at the other side of the hybrid adapter.

Also disclosed is the hybrid fiber and electrical connector and adapter system, wherein the

conductor at the bottom of the connector housing is connected to a conductive sleeve, which can terminate the electrical wire of a field cable by crimping.

Also disclosed is the hybrid fiber and electrical connector and adapter system, wherein the conductor at the bottom of the connector housing is connected to a conductive sleeve which can terminate the electrical wire of a field cable by tightening the screw on the conductive sleeve.

Also disclosed is the hybrid fiber and electrical connector, wherein the fiber optic connector features a stub fiber with one pre-polished end at the fiber optic connector's endface. In contrast, the stub fiber's other end can be seamlessly connected to a field fiber to install a fiber optic connector on a fiber optic cable.

Also disclosed is the hybrid fiber and electrical adapter, wherein the hybrid adapter has shutters to prevent the ingress of dust and debris while safeguarding the eyes of workers or technicians involved in the installation or maintenance of a fiber optic system.

Also disclosed is the hybrid fiber and electrical connector and adapter system, wherein the hybrid fiber and electrical connector and adapter system can be installed on a patch panel or in a cassette.

Disclosed is a hybrid LC fiber and electrical connector and adapter system comprising two simplex LC fiber optic connectors and a simplex LC fiber optic adapter, wherein the two fiber optic connectors can be connected to each other via the fiber optic adapter, wherein the fiber optic connectors have at least one conductor on the top of the connector housing, close to the connector latch, whereby at least one conductor on the top of the connector is aligned to contact the conductor in the fiber optic adapter, wherein the fiber optic adapter has at least one conductor at the top of the adapter housing, close to the latch, and is aligned to contact at least one conductor on the top of the connector housing of both the fiber optic connectors at each side, wherein an insulative protector is attached to the top of the connector to protect the user from touching the conductor on the top of the connector, and a gap exists between the protector and the conductor on the hybrid connector to allow it to be inserted into the hybrid adapter, wherein the fiber optic connectors have at least one conductor at the bottom of the connector housing, whereby at least one conductor at the bottom of the connector housing is aligned to contact the conductor at the bottom of the fiber optic adapter, wherein the fiber optic adapter has at least one conductor at the bottom of the adapter housing and is aligned to contact at least one conductor at the bottom of both the fiber optic connectors at each side, wherein at least two vertical insulative protectors are located at both sides of the conductor at the bottom of the connector. The vertical insulative protectors are taller than the conductor at the bottom of the connector so that the connector's conductor is recessed between two insulative protectors to prevent the user from touching the conductor at the bottom of the connector while allowing the conductor at the bottom of the connector to contact the conductor at the bottom of the adapter when the connector is inserted into the adapter.

Also disclosed is the hybrid fiber and electrical connector and adapter system, wherein the conductors on the hybrid connector are flat conductive plates, and the conductors in the hybrid adapter are conductive leaf springs.

Also disclosed is the hybrid fiber and electrical connector and adapter system, wherein the conductive leaf springs in the hybrid adapter have protrusion toward the conductive plates on the hybrid connector to allow good contact and provide a normal force between the conductive leaf springs and the conductive plates so that electrical power from the hybrid connector at one side of the hybrid adapter can be transferred to the hybrid connector at the other side of the hybrid adapter.

Also disclosed is the hybrid fiber and electrical connector and adapter system, wherein the conductors on the hybrid connector are conductive leaf springs, and the conductors in the hybrid adapter are flat conductive plates.

Also disclosed is the hybrid fiber and electrical connector and adapter system, wherein the conductive leaf springs on the hybrid connectors have protrusion toward the conductive plates in the hybrid adapter to allow good contact and provide a normal force between the conductive leaf springs and the conductive plates so that electrical power from the hybrid connector at one side of the hybrid adapter can be transferred to the hybrid connector at the other side of the hybrid adapter.

Also disclosed is the hybrid fiber and electrical connector and adapter system, wherein the conductors on connectors are connected to conductive sleeves, which can terminate the electrical wires of field cables by crimping.

Also disclosed is the hybrid fiber and electrical connector and adapter system, wherein the conductors on the connector housing are connected to conductive sleeves, which can terminate the electrical wires of field cables by tightening the screw on the conductive sleeves.

Also disclosed is the hybrid fiber and electrical connector, wherein the fiber optic connector features a stub fiber with one pre-polished end at the fiber optic connector's endface. In contrast, the stub fiber's other end can be seamlessly connected to a field fiber to install a fiber optic connector on a fiber optic cable.

Also disclosed is the hybrid fiber and electrical adapter, wherein the hybrid adapter has shutters to prevent the ingress of dust and debris while safeguarding the eyes of workers or technicians involved in the installation or maintenance of a fiber optic system.

Also disclosed is the hybrid fiber and electrical connector and adapter system, wherein the hybrid fiber and electrical connector and adapter system can be installed on a patch panel or in a cassette.

Disclosed is a hybrid LC fiber and electrical connector and adapter system comprising two duplex LC fiber optic connectors and a duplex LC fiber optic adapter, wherein the two pairs of fiber optic connectors can be connected to each other via the duplex fiber optic adapter, wherein the fiber optic connectors have at least one conductor on the top of the connector housing, close to the connector latch, whereby at least one conductor on the top of the connector is aligned to contact the conductor in the fiber optic adapter, wherein the fiber optic adapter has at least one conductor at the top of the adapter housing, close to the latch, and is aligned to contact at least one conductor on the top of the connector housing of both the fiber optic connectors at each side, wherein an insulative protector is attached to the top of the connector to protect the user from touching the conductor on the top of the connector, and a gap exists between the protector and the conductor on the hybrid connector to allow it to be inserted into the hybrid adapter, wherein the fiber optic connectors have at least one conductor at the bottom of the connector housing, whereby at least one conductor at the bottom of the connector housing is aligned to contact the conductor at the bottom of the fiber optic adapter, wherein the fiber optic adapter has at least one conductor at the bottom of the adapter housing and is aligned to contact at least one conductor at the bottom of both the fiber optic connectors at each side, wherein at least two vertical insulative protectors are located at both sides of the conductor at the bottom of the connector. The vertical insulative protectors are taller than the conductor at the bottom of the connector so that the connector's conductor is recessed between two insulative protectors to prevent the user from touching the conductor at the bottom of the connector while allowing the conductor at the bottom of the connector to contact the conductor at the bottom of the adapter when the connector is inserted into the adapter.

Also disclosed is the hybrid fiber and electrical connector and adapter system, wherein the conductors on the hybrid connector are flat conductive plates, and the conductors in the hybrid adapter are conductive leaf springs.

Also disclosed is the hybrid fiber and electrical connector and adapter system, wherein the conductive leaf springs in the hybrid adapter have protrusion toward the conductive plates on the hybrid connector to allow good contact and provide a normal force between the conductive leaf springs and the conductive plates so that electrical power from the hybrid connector at one side of the hybrid adapter can be transferred to the hybrid connector at the other side of the hybrid adapter.

Also disclosed is the hybrid fiber and electrical connector and adapter system, wherein the conductors on the hybrid connector are conductive leaf springs, and the conductors in the hybrid adapter are flat conductive plates.

Also disclosed is the hybrid fiber and electrical connector and adapter system, wherein the conductive leaf springs on the hybrid connectors have protrusion toward the conductive plates in the hybrid adapter to allow good contact and provide a normal force between the conductive leaf springs and the conductive plates so that electrical power from the hybrid connector at one side of the hybrid adapter can be transferred to the hybrid connector at the other side of the hybrid adapter. Also disclosed is the hybrid fiber and electrical connector and adapter system, wherein the conductors on connectors are connected to conductive sleeves, which can terminate the electrical wires of field cables by crimping.

Also disclosed is the hybrid fiber and electrical connector and adapter system, wherein the conductors on the connector housing are connected to conductive sleeves, which can terminate the electrical wires of field cables by tightening the screw on the conductive sleeves.

Also disclosed is the hybrid fiber and electrical connector, wherein the fiber optic connector features a stub fiber with one pre-polished end at the fiber optic connector's endface. In contrast, the stub fiber's other end can be seamlessly connected to a field fiber to install a fiber optic connector on a fiber optic cable.

Also disclosed is the hybrid fiber and electrical adapter, wherein the hybrid adapter has shutters to prevent the ingress of dust and debris while safeguarding the eyes of workers or technicians involved in the installation or maintenance of a fiber optic system.

Also disclosed is the hybrid fiber and electrical connector and adapter system, wherein the hybrid fiber and electrical connector and adapter system can be installed on a patch panel or in a cassette.

Disclosed is a hybrid fiber and electrical connector comprising at least one fiber optic connector, wherein the fiber optic connector has at least one conductor at the bottom of the connector housing, wherein the conductor has a length between 10 to 20 mm, a width between 0.5 to 4 mm, a thickness between 0.1 to 1.0 mm, wherein at least two vertical insulative protectors are located at both sides of the conductor at the bottom of the connector, wherein the vertical insulative protectors are taller than the connector's conductor so that the connector's conductor is recessed between two insulative protectors to prevent the user from touching the conductor on the connector, wherein the vertical insulative protector has a length between 5 to 20 mm, a depth between 0.5 to 4 mm, a thickness between 0.1 to 1.0 mm.

Also disclosed is the hybrid fiber and electrical connector, whereby at least one fiber optic connector is a simplex LC, CS, SN, or SC type.

Also disclosed is the hybrid fiber and electrical connector, whereby at least one connector is a multifiber MTP/MPO type.

Also disclosed is the hybrid fiber and electrical adapter containing at least one conductor at the bottom of the adapter housing, wherein the conductor has a length between 5 to 20 mm, a width between 0.5 to 4 mm, a thickness between 0.1 to 1.0 mm.

Also disclosed is the hybrid fiber and electrical adapter, whereby the adapter is configured to house at least one fiber optic connector of the simplex LC, CS, SN, or SC type.

Also disclosed is the hybrid fiber and electrical adapter, whereby the adapter is configured to house one multifiber fiber optic MTP/MPO connector type.

Disclosed is a hybrid fiber and electrical connector comprising at least one simplex LC fiber optic connector, wherein the fiber optic connector has at least one conductor on the top of the connector housing, close to the connector latch, wherein the conductor has a length between 10 to 20 mm, a width between 0.5 to 4 mm, a thickness between 0.1 to 1.0 mm, wherein an insulative protector is attached to the top of the connector to protect the user from touching the conductor on the connector, and a gap exists between the protector and the conductor on the hybrid connector to allow it to be inserted into the hybrid adapter.

Also disclosed is the hybrid LC fiber and electrical adapter containing at least one conductor at the top of the adapter housing, close to the latch, wherein the conductor has a length between 5 to 20 mm, a width between 0.5 to 4 mm, a thickness between 0.1 to 1.0 mm.

Disclosed is a hybrid MPO fiber and electrical connector and adapter system comprising two MPO connectors and an MPO adapter, wherein the two MPO connectors can be connected to each other via the MPO adapter, wherein the MPO connectors have at least one conductor at either the top or the bottom of the connector, whereby at least one conductor at either the top or the bottom of the connector is aligned to contact the conductor in the MPO adapter, wherein the MPO adapter has at least one conductor at either the top or the bottom inside of the adapter housing and is aligned to contact at least one conductor of both the fiber optic connectors at each side, wherein at least one insulative protector is located at the front side of the connector. The insulative protector may enclose the connector's conductor so that each conductor is recessed within the insulative protector, ensuring it remains protected from human contact for enhanced safety.

Also disclosed is the hybrid MPO fiber and electrical connector and adapter system, wherein the conductors of the connectors are conductive leaf springs, and the conductor in the adapter is a conductive plate.

Also disclosed is the hybrid fiber and electrical connector and adapter system, wherein the conductive leaf spring of the connector has protrusion toward the conductive plates of the adapter to allow good contact and provide a normal force between the conductive leaf spring and the conductive plates so that electrical power from the hybrid connector at one side of the hybrid adapter can be transferred to the hybrid connector at the other side of the hybrid adapter.

Also disclosed is the hybrid fiber and electrical connector and adapter system, wherein the conductors at the connectors are conductive plates, and the conductors in the adapter are conductive leaf springs.

Also disclosed is the hybrid fiber and electrical connector and adapter system, wherein the conductive leaf springs in the adapter have protrusions toward the conductive plate of the connectors to allow good contact and provide a normal force between the conductive leaf springs and the conductive plate so that electrical power from the hybrid connector at one side of the adapter can be transferred to the hybrid connector at the other side of the hybrid adapter.

Also disclosed is the hybrid fiber and electrical connector and adapter system, wherein the conductors of the connectors are connected to conductive sleeves, which can terminate the electrical wires of field cables by crimping.

Also disclosed is the hybrid fiber and electrical connector and adapter system, wherein the conductors of the connectors are connected to conductive sleeves, which can terminate the electrical wires of field cables by tightening the screw on the conductive sleeves.

Also disclosed is the hybrid fiber and electrical connector and adapter system, wherein the hybrid fiber and electrical connectors and adapter system can be installed on a patch panel or in a cassette.

Also disclosed is the hybrid MPO fiber and electrical connector and adapter system, wherein four pairs of conductors are formed, with four conductors positioned on the top of the connectors and four conductors positioned at the bottom of the connectors. The two central pairs of conductors include a short circuit between the two top conductors and another short circuit between the two bottom conductors, forming one pair of conductors or one channel. Similarly, the two side pairs of conductors have a short circuit between the two top conductors and another short circuit between the two bottom conductors, forming another pair of conductors or another channel.

Also disclosed is the hybrid MPO fiber and electrical connector has at least one conductor on the connector and at least one insulative protector located at the front side of the connector. The insulative protector encloses the connector's conductor so that each conductor is recessed within the insulative protector, ensuring it remains protected from human contact for enhanced safety.

Also disclosed is the hybrid MPO fiber and electrical adapter that has at least one conductor in the adapter.

Disclosed is a hybrid MPO fiber and electrical connector and adapter system comprising two MPO connectors and an MPO adapter, wherein the two MPO connectors can be connected to each other via the MPO adapter, wherein the MPO connectors have at least one conductor at either the top or the bottom of the connector, whereby at least one conductor at either the top or the bottom of the connector is aligned to contact the conductor in the MPO adapter, wherein the MPO adapter has at least one conductor at either the top or the bottom inside of the adapter housing and is aligned to contact at least one conductor of both the fiber optic connectors at each side.

Also disclosed is the hybrid MPO fiber and electrical connector and adapter system, wherein at least one insulative protector is located at the front side of the connector. The insulative protector encloses the connector's conductor so that each conductor is recessed within the insulative protector, ensuring it remains protected from human contact for enhanced safety.

Also disclosed is the hybrid MPO fiber and electrical connector and adapter system, wherein the conductors of the connectors are conductive leaf springs, and the conductor in the adapter is a conductive plate.

Also disclosed is the hybrid fiber and electrical connector and adapter system, wherein the conductive leaf spring of the connector has protrusion toward the conductive plates of the adapter to allow good contact and provide a normal force between the conductive leaf spring and the conductive plates so that electrical power from the hybrid connector at one side of the hybrid adapter can be transferred to the hybrid connector at the other side of the hybrid adapter.

Also disclosed is the hybrid fiber and electrical connector and adapter system, wherein the conductors of the connectors are conductive plates, and the conductors in the adapter are conductive leaf springs.

Also disclosed is the hybrid fiber and electrical connector and adapter system, wherein the conductive leaf springs in the adapter have protrusions toward the conductive plate of the connectors to allow good contact and provide a normal force between the conductive leaf springs and the conductive plate so that electrical power from the hybrid connector at one side of the adapter can be transferred to the hybrid connector at the other side of the hybrid adapter.

Also disclosed is the hybrid fiber and electrical connector and adapter system, wherein the conductors of the connectors are connected to conductive sleeves, which can terminate the electrical wires of field cables by crimping.

Also disclosed is the hybrid fiber and electrical connector and adapter system, wherein the conductors of the connectors are connected to conductive sleeves, which can terminate the electrical wires of field cables by tightening the screw on the conductive sleeves.

Also disclosed is the hybrid fiber and electrical connector and adapter system, wherein the hybrid fiber and electrical connectors and adapter system can be installed on a patch panel or in a cassette.

Also disclosed is the hybrid MPO fiber and electrical connector and adapter system, wherein four pairs of conductors are formed, with four conductors positioned on the top of the connectors and four conductors positioned at the bottom of the connectors. The two central pairs of conductors include a short circuit between the two top conductors and another short circuit between the two bottom conductors, forming one pair of conductors or one channel. Similarly, the two side pairs of conductors have a short circuit between the two top conductors and another short circuit between the two bottom conductors, forming another pair of conductors or another channel.

Also disclosed is the hybrid MPO fiber and electrical connector has at least one conductor on the connector.

The present disclosure thus describes systems, devices, and methods for implementing a hybrid cable connector and adapter system and a method for utilizing the hybrid cable connector and adapter system. As is readily apparent from the foregoing, various non-limiting embodiments of the hybrid cable connector and adapter system, device, and methods for utilizing the hybrid cable connector and adapter system have been described. While various embodiments have been illustrated and described herein, they are exemplary only and it is not intended that these embodiments illustrate and describe all those possible. Instead, the words used herein are words of description rather than limitation, and it is understood that various changes may be made to these embodiments without departing from the spirit and scope of the following claims.

What is claimed is:

1. A hybrid cable connector comprising:
a connector housing comprising:
a first recessed channel formed at a bottom portion of the connector housing, the first recessed channel including a first wall and a second wall; and
a second recessed channel formed at the bottom portion of the connector housing, the second recessed channel including a third wall and a fourth wall; and
a pair of leaf springs including a first leaf spring and a second leaf spring, the first leaf spring installed inside the first recessed channel and the second leaf spring installed inside the second recessed channel attached to the bottom portion of the first connector housing;
wherein the first wall and the second wall protrude higher than the first leaf spring installed inside the first recessed channel;
wherein the third wall and the fourth wall protrude higher than the second leaf spring installed inside the second recessed channel.

2. The hybrid cable connector of claim 1, wherein the pair of leaf springs are configured to contact a pair of conductive plates in a hybrid adapter when the hybrid cable connector is installed in the hybrid adapter.

3. The hybrid cable connector of claim 1, wherein the first leaf spring includes an angled protrusion.

4. The hybrid cable connector of claim 1, wherein the second leaf spring includes an angled protrusion.

5. A duplex hybrid cable connector comprising:
a first connector housing including a first top surface;
a second connector housing including a second top surface;
a first pair of conductive leaf springs installed onto the first top surface of the first connector housing;
a second pair of leaf springs installed onto the second top surface of the second connector housing; and
a push-pull clip including an insulative protector configured to cover over at least a portion of the first pair of conductive leaf springs and the second pair of conductive leaf springs.

6. The duplex hybrid cable connector of claim 5, wherein the first leaf spring includes an angled protrusion.

7. The duplex hybrid cable connector of claim 5, wherein the second leaf spring includes an angled protrusion.

8. The duplex hybrid cable connector of claim 5, wherein the insulative protector comprises a top cover, a first side wall, and a second side wall.

9. The duplex hybrid cable connector of claim 5, the first connector housing further comprising a pair of first front posts that protrude up from the first top surface, the pair of first front posts configured to prevent the first pair of leaf springs from falling past the first front posts.

10. The duplex hybrid cable connector of claim 5, the second connector housing further comprising a pair of second front posts that protrude up from the second top surface, the pair of second front posts configured to prevent the second pair of leaf springs from falling past the second front posts.

11. A hybrid cable connector comprising:
a connector housing including a top surface and a bottom surface;
a first set of conductive leaf springs installed onto the top surface;
a second set of leaf springs installed onto the bottom surface; and
a push-pull clip including an insulative protector configured to cover over at least a portion of the first set of conductive leaf springs and the second set of conductive leaf springs.

12. The hybrid cable connector of claim 11, wherein the first set of conductive leaf springs include up to four leaf springs.

13. The hybrid cable connector of claim 11, wherein the second set of conductive leaf springs include up to four leaf springs.

14. The hybrid cable connector of claim 11, wherein the hybrid cable connector includes an MPO connector front face, including a plurality of fiber ferrules and a pair of pins on the front face.

15. The hybrid cable connector of claim 11, wherein the hybrid cable connector includes a duplex LC form factor comprising a first LC connector and a second LC connector.
